(19) United States
(12) Patent Application Publication
(10) Pub. No.: US 2026/0002701 A1
(43) Pub. Date: Jan. 1, 2026

(54) Method of Cleaning Out a Water Heater

(71) Applicant: Geoffrey H Carson, Lake Ozark, MO (US)

(72) Inventor: Geoffrey H Carson, Lake Ozark, MO (US)

(21) Appl. No.: 19/172,200

(22) Filed: Apr. 7, 2025

Related U.S. Application Data
(63) Continuation-in-part of application No. 18/756,192, filed on Jun. 27, 2024, now Pat. No. 12,270,576.

(51) Int. Cl. F24H 9/00; B08B 9/043

(52) U.S. Cl. CPC F24H 9/0042; B08B 9/0436; B08B 2205/00

(57) ABSTRACT

A method for removing built-up solids from a water heater using a vacuum-based clean-out device is disclosed. The method includes disconnecting power and water, draining the heater, and inserting a vacuum pipe through an access opening. Suction is applied while an articulating joint and pull cord mechanism direct the vacuum pipe to remove sediment. Additional steps include rotating the pipe, adjusting its length, using sensors for positioning, and applying vibration to dislodge deposits. The method supports insertion through a heating element port or drain valve opening and allows flushing with water post-cleaning. Compatible with shop vacuums, wet/dry vacuums, and central vacuums, this method improves cleaning efficiency and heater performance.

### CROSS-REFERENCE TO RELATED APPLICATIONS

This application is a continuation-in-part of application Ser. No. 18/756,192, titled “Water Heater Clean Out Device and Method of Cleaning Out a Water Heater,” filed by Geoffrey H. Carson.

### BACKGROUND OF THE INVENTION

### Technical Field

This invention relates generally to a water heater maintenance system. This invention relates more particularly to an apparatus for removing built-up sediment and debris from the bottom of a water heater using a vacuum-based extraction method.

This invention relates generally to apparatuses and devices for cleaning and maintaining water heaters to improve efficiency and longevity. This method also can be used with various types of water heaters, including residential, commercial, and industrial units. This invention relates more particularly to a vacuum-based clean-out device to remove accumulated solids and prevent heater damage.

This invention pertains to the field of water heater maintenance and cleaning systems. More specifically, the invention relates to apparatuses and methods for removing accumulated solids, debris, and sediment from the interior of water heaters to enhance operational efficiency and prolong the lifespan of heating components.

The invention is applicable to the field of fluid storage tank maintenance, particularly in relation to devices and methods for dislodging and extracting built-up material from the bottom of enclosed water storage tanks, including but not limited to electric and gas-powered water heaters.

The field further includes cleaning and maintenance systems designed to improve heat transfer efficiency in water heating appliances by reducing sediment-induced insulation effects, which can decrease heating performance and increase energy consumption.

The subject matter of this invention aligns with technologies related to fluid-handling equipment, vacuum-based extraction systems, articulating cleaning tools, and sensor-assisted maintenance devices. The invention provides a structured method and apparatus for accessing, cleaning, and monitoring sediment levels within enclosed water heating units.

This invention also pertains to the broader field of home and commercial appliance maintenance tools, including vacuum-assisted removal systems, articulating cleaning mechanisms, and automated or semi-automated cleaning enhancements for hard-to-reach internal surfaces.

### Background Art

Water heaters commonly accumulate sediment and mineral deposits at the bottom of the tank over time due to impurities present in the water supply. These deposits can reduce heating efficiency, cause premature failure of heating elements, lead to corrosion, and increase energy consumption. Routine maintenance is required to remove sediment buildup, but existing methods are often inefficient, labor-intensive, and may not fully eliminate accumulated debris.

Conventional methods for cleaning water heaters typically involve flushing the tank by attaching a hose to the drain valve and allowing water to flow out under pressure. However, this method often fails to remove all sediment, especially heavier or compacted deposits that settle at the bottom of the tank. Additionally, drain valve openings are relatively small, limiting the effectiveness of traditional flushing techniques.

Some cleaning tools have been developed to improve sediment removal by introducing high-pressure water jets into the tank. While these tools help dislodge deposits, they do not provide a means for directly extracting the loosened debris, which may still require multiple flushing cycles to fully remove. Moreover, water jet cleaning can create turbulence that redistributes sediment rather than eliminating it.

Other known methods include using vacuum-based extraction, but these typically involve manually inserting a rigid tube into the heater, which has limited maneuverability and does not effectively reach all areas of the bottom surface. Without articulation or repositioning mechanisms, such systems are unable to ensure complete coverage of the interior of the tank, leaving behind residual deposits.

A significant limitation of prior cleaning systems is the lack of control over the movement of the cleaning tool within the tank. In most cases, users must manually reposition the tool by tilting or shaking the water heater itself or rely on unpredictable water flow patterns to move sediment toward the drain valve. These approaches are inefficient, cumbersome, and often fail to provide thorough cleaning.

Furthermore, prior art cleaning methods do not incorporate sensor-based detection of sediment levels, meaning users must estimate the thoroughness of cleaning through trial and error. The absence of feedback mechanisms can result in incomplete cleaning or unnecessary extended maintenance times.

Accordingly, there remains a need for an improved water heater cleaning system that effectively removes built-up solids, provides controlled articulation for precise sediment extraction, offers multiple access point options for insertion, and includes features such as extendable vacuum pipes and sensor-assisted monitoring to enhance cleaning efficiency. The present invention addresses these deficiencies and provides a superior solution to the problems inherent in the prior art.

In light of the foregoing prior art, there is a need for a vacuum-based water heater cleaning device to better remove built-up sediment and debris from the bottom of a water heater in a controlled and efficient manner.

### BRIEF SUMMARY OF THE INVENTION

The present invention relates to a vacuum-based water heater cleaning device and method designed to effectively remove built-up solids and sediment from the bottom of a water heater. Unlike traditional flushing methods that rely on water flow and agitation, this invention utilizes a vacuum-based extraction system, allowing for more efficient and controlled removal of accumulated debris.

The inventive concept of the present invention lies in the incorporation of an articulating vacuum pipe end that can be manipulated using a pull cord mechanism or a motorized joint. This feature enables precise positioning of the vacuum pipe within the water heater, ensuring comprehensive cleaning coverage of the bottom surface where sediment tends to accumulate.

Another novel aspect of the invention is the ability to insert the vacuum pipe through multiple access points, including the heating element port and the drain valve opening. This flexibility allows users to access and clean water heaters with different configurations without requiring extensive modifications.

Additionally, the invention includes an extendable vacuum pipe section to accommodate varying water heater depths, as well as an optional auxiliary vibrating or pulsating mechanism to assist in dislodging stubborn deposits.

A key advantage of the invention is the incorporation of sensor-based sediment detection, which allows for real-time monitoring and feedback on the presence of debris. This enables users to adjust the articulation and positioning of the vacuum pipe dynamically, improving cleaning efficiency and reducing the need for repeated maintenance cycles.

The invention further improves water heater maintenance by incorporating an external indicator system to track vacuum pipe movement and ensure complete coverage of the bottom of the tank. After vacuuming, a post-cleaning flushing step may be performed to remove any remaining debris, leaving the water heater in an optimal state for continued operation.

By addressing the inefficiencies of prior art methods, the present invention provides a more effective and user-friendly solution for water heater cleaning and maintenance. It reduces sediment-related issues that can lead to decreased heating efficiency, higher energy costs, and premature heater failure.

Accordingly, the present invention offers an innovative, efficient, and practical approach to maintaining water heaters, solving long-standing challenges associated with sediment buildup while minimizing user effort and improving overall cleaning effectiveness.

According to a first aspect of the invention, there is a water heater clean-out device comprising a method for removing built-up solids from the bottom of a water heater using a vacuum-based extraction system. The method includes disconnecting the power supply, turning off the water supply, draining the water heater to expose accumulated sediment, inserting a vacuum pipe through an access opening, and activating a vacuum source to create suction for sediment removal. The vacuum pipe end is manipulated using an articulating joint to ensure comprehensive cleaning, with progressive repositioning enabled by a pull cord mechanism. After cleaning, the vacuum pipe is removed, and the sediment removal is verified.

Further features of the invention are disclosed in dependent aspects as follows: According to a second aspect of the present invention, there is a water heater clean-out device in the form of an articulating vacuum pipe for precise positioning and maneuverability within the water heater. An advantage of the articulating vacuum pipe is that it allows for targeted removal of sediment without requiring repositioning of the entire device or reliance on unpredictable water flow patterns.

According to a third aspect of the invention, there is a water heater clean-out device in the form of a pull cord mechanism for adjusting the articulation of the vacuum pipe. An advantage of the pull cord mechanism is that it provides manual control over the vacuum pipe's movement, enabling users to access and clean different areas of the heater with precision.

According to a fourth aspect of the invention, there is a water heater clean-out device in the form of a vacuum pipe that can be inserted through a heating element port after the removal of a lower heating element. An advantage of this feature is that it provides an alternative access point for inserting the cleaning device, making it adaptable to various water heater configurations.

According to a fifth aspect of the invention, there is a water heater clean-out device in the form of a vacuum pipe that can be inserted through a drain valve opening after removal of the drain valve. An advantage of this feature is that it utilizes an existing opening in the water heater, eliminating the need for modifications or additional access points.

According to a sixth aspect of the invention, there is a water heater clean-out device in the form of a motorized articulating joint for automated movement of the vacuum pipe. An advantage of the motorized articulating joint is that it enhances the efficiency of cleaning by allowing controlled movement of the vacuum pipe without requiring manual adjustments.

According to a seventh aspect of the invention, there is a water heater clean-out device in the form of an external indicator or sensor for monitoring the movement of the vacuum pipe within the heater. An advantage of the external indicator or sensor is that it provides visual or electronic feedback to the user, ensuring complete coverage of the bottom surface and reducing the likelihood of missed sediment.

According to an eighth aspect of the invention, there is a water heater clean-out device in the form of an extendable vacuum pipe section for reaching different depths within the water heater. An advantage of the extendable vacuum pipe section is that it allows the cleaning device to adapt to different tank sizes and configurations, improving accessibility and cleaning efficiency.

According to a ninth aspect of the invention, there is a water heater clean-out device in the form of an auxiliary vibrating or pulsating mechanism attached to the vacuum pipe end for assisting in dislodging stubborn deposits. An advantage of this mechanism is that it enhances the removal of hardened sediment that may otherwise resist vacuum extraction alone.

According to a tenth aspect of the invention, there is a water heater clean-out device in the form of a sensor positioned on the vacuum pipe end for detecting the presence of sediment and adjusting articulation based on real-time feedback. An advantage of the sediment detection sensor is that it ensures efficient and thorough cleaning by directing the vacuum pipe to areas where sediment is still present.

According to an eleventh aspect of the invention, there is a water heater clean-out device in the form of a post-vacuum flushing step for removing any residual debris after sediment extraction. An advantage of the post-vacuum flushing step is that it ensures a completely clean water heater before refilling, reducing potential buildup from loosened particles.

According to a twelfth aspect of the invention, there is a water heater clean-out device in the form of a vacuum source, which may comprise a shop vacuum, a wet/dry vacuum, or a central vacuum system. An advantage of this feature is that it allows for high-powered sediment removal without requiring specialized or proprietary equipment.

An advantage of the water heater clean-out device is that it utilizes a vacuum-based extraction method, which effectively removes built-up solids without relying on water flushing, reducing the risk of re-depositing sediment inside the heater.

An advantage of the articulating vacuum pipe is that it can be manually or motorizedly adjusted to target specific areas within the water heater, ensuring more thorough sediment removal compared to static cleaning devices.

An advantage of the pull cord mechanism is that it allows for precise repositioning of the vacuum pipe within the heater without requiring disassembly of the unit, increasing ease of use.

An advantage of the multiple access point insertion design is that the vacuum pipe can be inserted through either the heating element port or the drain valve opening, providing flexibility depending on the water heater's configuration.

An advantage of the extendable vacuum pipe section is that it can be adjusted to reach different depths within the heater, allowing comprehensive cleaning regardless of the water heater's size.

An advantage of the sensor-based sediment detection system is that it enables real-time monitoring of sediment presence, allowing the user to adjust the articulation of the vacuum pipe for more efficient cleaning.

An advantage of the motorized articulation mechanism is that it enhances the precision and control of the vacuum pipe's movement, reducing manual effort and improving the effectiveness of sediment removal.

An advantage of the auxiliary vibrating or pulsating mechanism is that it helps dislodge stubborn deposits, making it easier for the vacuum to remove hardened or compacted sediment.

An advantage of the external indicator system is that it provides visual or electronic feedback on the vacuum pipe's position, ensuring complete coverage of the bottom of the water heater during the cleaning process.

An advantage of the post-vacuum flushing step is that it removes any residual debris after vacuuming, ensuring that the water heater is completely free of loosened particles before being refilled.

An advantage of the use of a shop vacuum, wet/dry vacuum, or central vacuum system as the vacuum source is that it allows for high-powered sediment removal without requiring specialized or proprietary equipment.

An advantage of the present invention over existing cleaning products is that it provides a more effective and automated solution compared to traditional water flushing or static vacuum attachments, reducing maintenance time and effort.

An advantage of the invention's compatibility with common water heater models is that it can be used in both residential and commercial applications without requiring modifications to the heater.

An advantage of the invention is that it reduces the risk of water heater inefficiency and failure by thoroughly removing sediment that can cause heating element damage, corrosion, and reduced energy efficiency.

An advantage of the invention is that it offers a cost-effective and user-friendly solution for water heater maintenance, enabling homeowners and professionals to perform thorough cleaning without expensive service calls.

The invention will now be described, by way of example only, with reference to the accompanying drawings in which:

### BRIEF DESCRIPTION OF THE SEVERAL VIEWS OF THE DRAWINGS

FIG. 1A is a flowchart of the method of using a water heater clean out device according to the invention; and

FIG. 1B is a continued flowchart of the method of using a water heater clean out device according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise,” or variations thereof such as “comprises” or “comprising,” will be understood to imply the inclusion of a stated element, integer or step, or group of elements integers, or steps, but not the exclusion of any other element, integer, or step, or group of elements, integers, or steps.

Throughout this specification, the phrase “vacuum cleaner,” or variations thereof such as “vacuum,” will be understood to imply the inclusion of any type of household appliance or device that is designed to remove dirt, dust, debris, and other particles from floors, carpets, upholstery, and other surfaces through the use of suction. It works by creating a partial vacuum inside a chamber, which causes air to rush in and carry dirt and particles into a dust collection bag, bin, or canister. Here are some common types of vacuum cleaners:

Upright Vacuum Cleaner: Upright vacuum cleaners are the most traditional and common type. They typically feature a motor and suction head in a single unit, with a handle and dust collection bin or bag attached. Upright vacuums are well-suited for cleaning carpets and large areas, and they often come with attachments for versatile cleaning.

Canister Vacuum Cleaner: Canister vacuum cleaners consist of a separate unit containing the motor and dust collection bin connected to a long hose and wand. They offer more maneuverability and are suitable for cleaning stairs, upholstery, and hard-to-reach areas. Canister vacuums are versatile and often come with various attachments for different cleaning tasks.

Stick Vacuum Cleaner: Stick vacuum cleaners are lightweight and slim, resembling a stick with a small motorized head at the base. They are ideal for quick and convenient cleanups on hard floors and low-pile carpets. Stick vacuums are easy to maneuver and store, making them suitable for small living spaces.

Handheld Vacuum Cleaner: Handheld vacuum cleaners are compact and portable units designed for spot cleaning and quick pickups. They are great for cleaning upholstery, car interiors, and tight spaces such as stairs and corners. Handheld vacuums are battery-powered and come in corded or cordless models.

Robot Vacuum Cleaner: Robot vacuum cleaners, also known as robotic vacuums, are autonomous devices equipped with sensors and navigation technology to clean floors automatically. They can navigate around furniture and obstacles, making them convenient for daily maintenance cleaning. Robot vacuums are best suited for hard floors and low-pile carpets.

Wet/Dry Vacuum Cleaner: Wet/dry vacuum cleaners are versatile machines capable of picking up both dry debris and liquid spills. They are often used for cleaning workshops, garages, and outdoor areas. Wet/dry vacuums typically have larger capacities and stronger motors than regular vacuum cleaners.

Central Vacuum System: Central vacuum systems consist of a central unit installed in a home or building, connected to in-wall piping and vacuum ports throughout the premises. They offer powerful suction and quiet operation, with the dust collection unit located away from living spaces, reducing noise and allergen exposure.

Throughout this specification, the phrase “articulating joint,” or variations thereof, will be understood to imply the inclusion of any type of mechanism or connection point that allows for movement or adjustment between two or more components. These joints are designed to enable flexibility, positioning, and range of motion, similar to how articulating joints in the human body facilitate movement between bones. Here are some common types of articulating joints found in tools and devices:

Swivel Joint: Swivel joints allow rotation around a fixed point or axis. They are commonly found in tools such as swivel chairs, camera mounts, and hose connectors.

Universal Joint: Also known as a Cardan joint, universal joints transmit rotary motion between shafts that are not in a straight line. They are widely used in driveshafts of vehicles, machinery, and robotics to transfer torque between misaligned shafts.

Ball Joint: Ball joints consist of a ball and socket mechanism that allows rotation in multiple axes. They are commonly used in automotive suspension systems, steering linkages, and some types of machinery.

Hinge Joint: Hinge joints in tools and devices function similarly to those in the human body, allowing movement along one axis. They are found in applications such as doors, gates, and folding mechanisms.

Pivot Joint: Pivot joints in tools enable rotational movement around a fixed point. They are used in various applications such as adjustable lamps, articulating arms, and certain types of clamps.

Linkage Joint: Linkage joints consist of multiple interconnected links that allow complex movement patterns. They are commonly found in robotics, industrial machinery, and articulated tools such as excavators and cranes.

Articulating Arm: An articulating arm is a type of jointed mechanism that allows for precise positioning and movement. They are used in applications such as industrial robots, medical devices, and drafting lamps.

Spherical Rod End: Spherical rod ends, also known as Heim joints or rose joints, provide articulation in a single plane. They are commonly used in mechanical linkages, control systems, and suspension components.

Index of Labelled Features in Figures. Features are listed in numeric order.

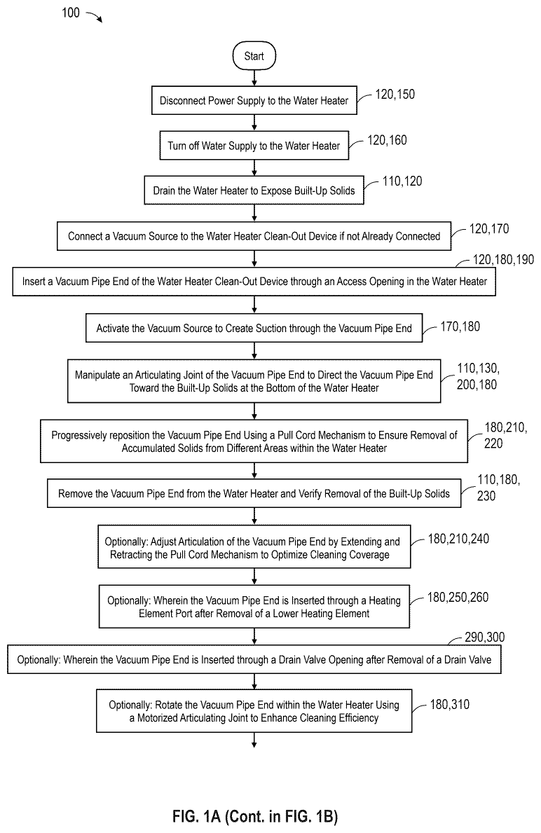

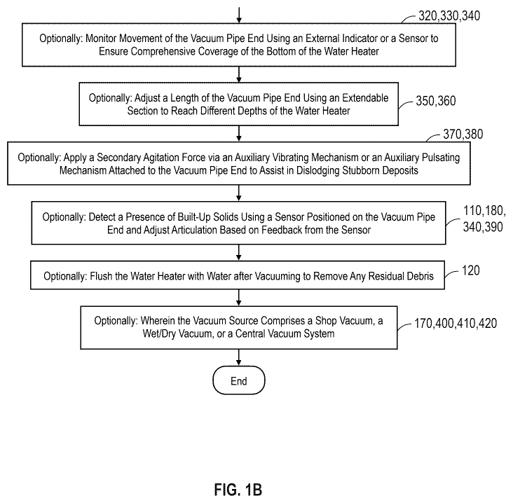

Referring to the Figures, there is shown in FIGS. 1A and 1B the following features:
Element 100 which is a method of cleaning built-up solids from a bottom of a water heater using a water heater clean-out device.
Element 110 which is a built-up solid.
Element 120 which is a water heater.
Element 130 which is a bottom of a water heater.
Element 140 which is a water heater clean-out device.
Element 150 which is a power supply.
Element 160 which is a water supply.
Element 170 which is a vacuum source.
Element 180 which is a vacuum pipe end.
Element 190 which is an access opening in the water heater.
Element 200 which is an articulating joint.
Element 210 which is a pull cord mechanism.
Element 220 which is an accumulated solid.
Element 230 which is a removal of the built-up solids.
Element 240 which is an articulation.
Element 250 which is a heating element port.
Element 260 which is a lower heating element
Element 290 which is a drain valve opening.
Element 300 which is a drain valve.
Element 310 which is a motorized articulating joint.
Element 320 which is a movement of the vacuum pipe end.
Element 330 which is an external indicator.
Element 340 which is a sensor.
Element 350 which is a length of the vacuum pipe end.
Element 360 which is an extendable section
Element 370 which is a secondary agitation force.
Element 380 which is an auxiliary vibrating mechanism or an auxiliary pulsating mechanism.
Element 390 which is a presence of the built-up solids.
Element 400 which is a shop vacuum.
Element 410 which is a wet/dry vacuum.
Element 420 which is a central vacuum system.

The water heater clean-out device is constructed from a combination of rigid and flexible vacuum tubing, an articulating joint, a pull cord mechanism, an extendable vacuum pipe section, and an auxiliary vibrating or pulsating mechanism. The device is designed to be compatible with a standard shop vacuum, wet/dry vacuum, or central vacuum system for extracting built-up sediment from the bottom of a water heater.

To manufacture the articulating vacuum pipe, a flexible yet durable material such as reinforced rubber or plastic tubing is selected. The pipe includes an articulating joint at the end, which is controlled manually via a pull cord mechanism or motorized articulation. The pull cord is threaded through the length of the vacuum pipe and connected to the articulating joint to allow for precise manual movement.

A motorized articulating joint can be made using a small servo or stepper motor housed in a protective casing. The motor is connected to a control mechanism that adjusts the angle of the vacuum pipe end. A wireless remote or button-operated controller may be integrated for automated movement.

The extendable vacuum pipe section consists of telescoping tubes made from lightweight, rigid materials such as aluminum or PVC. These tubes fit within each other and can be adjusted by twisting or locking them into place. This feature allows the user to reach different depths within the water heater.

An auxiliary vibrating or pulsating mechanism is attached to the vacuum pipe end to help dislodge stubborn sediment. This mechanism may consist of a small vibration motor powered by a battery or external power source. The vibration motor is embedded in a rubberized housing to minimize noise and improve durability.

A sediment detection sensor, such as an optical or ultrasonic sensor, is installed at the vacuum pipe end. This sensor detects sediment presence and sends signals to adjust the articulation of the vacuum pipe. The sensor system may be wired or wireless, with real-time feedback displayed on an external indicator.

To allow multiple access point insertions, adapters for both heating element ports and drain valve openings are manufactured. These adapters are designed to form a secure, airtight connection between the vacuum pipe and the water heater opening, preventing air leaks that could reduce vacuum efficiency.

To use the water heater clean-out device, the user first disconnects the power supply to the water heater to ensure safety. If the heater is gas-powered, the gas supply is also turned off. Next, the water supply to the heater is shut off, and the tank is drained to expose built-up sediment at the bottom.

Once the tank is drained, the user determines the best access point for inserting the vacuum pipe. If using the heating element port, the lower heating element is removed, and the vacuum pipe is inserted through the opening. If using the drain valve opening, the drain valve is removed, and an appropriate adapter is attached to allow vacuum pipe insertion.

The vacuum pipe end is then positioned inside the heater, and a vacuum source such as a shop vacuum or wet/dry vacuum is connected to create suction. If the vacuum source is already connected, the user simply turns it on to initiate suction.

The pull cord mechanism is used to manually adjust the articulating vacuum pipe end to target different areas of sediment buildup. If the motorized articulation feature is included, the user can operate a remote control or button system to adjust the vacuum pipe's angle and movement.

For more effective cleaning, the user progressively repositions the vacuum pipe end throughout the bottom of the water heater. The external indicator or sensor system helps the user track vacuum pipe movement, ensuring all areas are covered. The sediment detection sensor provides feedback, allowing adjustments based on real-time sediment levels.

If stubborn deposits are encountered, the auxiliary vibrating or pulsating mechanism is activated. The vibration assists in breaking up compacted sediment, making it easier for the vacuum to extract. The extendable vacuum pipe section can be adjusted to reach different depths of the heater if needed.

After sediment removal is complete, the vacuum pipe is carefully removed from the heater. A post-vacuum flushing step is performed by turning the water supply back on and running clean water through the tank to rinse out any residual debris. The heater is then refilled, and the power or gas supply is restored.

An advantage of this method is that it provides a more efficient and thorough cleaning process compared to traditional flushing techniques, reducing the risk of sediment buildup, improving heating efficiency, and extending the lifespan of the water heater.

One option for the invention is the choice of vacuum source. The water heater clean-out device can be designed to work with a standard shop vacuum, a wet/dry vacuum, or a central vacuum system. The selection of the vacuum source may depend on the available equipment, power requirements, and the level of suction needed for effective sediment removal. A high-powered vacuum may be preferable for commercial water heaters with larger sediment accumulation, while a standard wet/dry vacuum may be sufficient for residential use.

Another option for the invention is the type of articulating mechanism used to control the vacuum pipe end. The articulating joint may be manually adjusted using a pull cord mechanism, or it may be motorized for automated movement. A manual pull cord system provides a cost-effective and mechanically simple solution, whereas a motorized articulation system offers greater precision and ease of use, particularly for users who need to clean hard-to-reach areas within the water heater.

An additional option is the method of accessing the water heater for sediment removal. The vacuum pipe can be inserted through either the heating element port after the removal of the lower heating element or through the drain valve opening after removing the drain valve. This flexibility allows the device to be compatible with different water heater designs and configurations.

The invention may also include different types of vacuum pipe extensions. A telescoping vacuum pipe with adjustable length can be used for water heaters of varying depths, allowing the user to extend or retract the pipe as needed. Alternatively, a fixed-length vacuum pipe can be provided in multiple sizes to accommodate different water heater models.

Another variation of the invention is the incorporation of auxiliary cleaning mechanisms. An optional vibrating or pulsating mechanism can be attached to the vacuum pipe end to help dislodge stubborn deposits. The vibration can be generated by a small motor-powered system or by an air pulse mechanism integrated into the vacuum pipe. This feature improves the efficiency of sediment removal, especially in cases where mineral buildup is hardened or compacted.

The invention may further include a sediment detection system with different sensor options. One approach is to use an optical sensor that detects variations in light reflection caused by sediment presence. Another option is to integrate an ultrasonic sensor that measures the density of accumulated solids in the bottom of the heater. These sensors provide real-time feedback to the user, allowing them to adjust the articulation and positioning of the vacuum pipe accordingly.

A user interface option can be added to enhance control over the cleaning process. For manual operation, the system may include a simple pull cord and visual guide for positioning. For motorized articulation, the device can feature a wireless remote control or a smartphone app that allows the user to adjust the vacuum pipe's movement and monitor sediment levels through an integrated display.

For professional or industrial applications, an advanced version of the invention can be developed with automated cleaning cycles. In this configuration, the vacuum pipe articulation and sediment detection sensors can work together to systematically scan and clean the bottom of the water heater without requiring manual user input. The device may also store cleaning cycle data, allowing users to track maintenance history and optimize future cleanings.

An additional option is the incorporation of a transparent viewing window in the access adapter to allow users to visually monitor sediment removal in real time. This feature can help confirm that all debris has been effectively extracted before refilling the water heater.

The invention may also be designed with various attachment heads for different cleaning scenarios. A standard vacuum nozzle can be used for general sediment removal, while a specialized brush attachment can be provided for scrubbing away stubborn deposits. A rotating nozzle attachment can further enhance cleaning effectiveness by directing suction in multiple directions as the pipe moves through the heater.

A portability option can be considered by designing the device as a self-contained unit with an integrated vacuum system, battery-powered motorized articulation, and a compact carrying case. This version would be ideal for service professionals who need a convenient and transportable solution for cleaning multiple water heaters at different locations.

For enhanced safety, the invention can include an automatic shutoff mechanism that detects when the vacuum pipe is removed from the water heater or when the cleaning process is complete. This feature helps prevent accidental overuse of the vacuum system and ensures that the cleaning cycle does not continue unnecessarily.

Finally, the materials used for the vacuum pipe and other components can vary depending on durability and flexibility requirements. Heat-resistant polymers or reinforced rubber can be used for applications where exposure to residual heat inside the water heater is a concern. Alternatively, lightweight aluminum or stainless steel components may be used for enhanced durability in professional-grade models.

In a preferred embodiment of the present invention, there is a water heater clean-out device comprising a method for removing built-up solids from the bottom of a water heater using a vacuum-based extraction system. The method involves disconnecting the power supply and shutting off the water supply to ensure safety. The water heater is then drained to expose the accumulated sediment at the bottom. A vacuum source, such as a shop vacuum, wet/dry vacuum, or central vacuum system, is connected to the clean-out device, and a vacuum pipe end is inserted through an access opening in the heater. The vacuum source is activated to create suction, allowing sediment removal. The vacuum pipe end is manipulated using an articulating joint, and a pull cord mechanism is used to progressively reposition the pipe for complete sediment extraction. After cleaning, the vacuum pipe is removed, and the sediment removal is verified before restoring the water heater to operation.

In an alternate embodiment of the present invention, there is a water heater clean-out device with an articulating vacuum pipe end that allows precise positioning of the suction inlet within the water heater. The articulating joint enables the user to direct the vacuum pipe toward different areas where sediment has settled, ensuring complete coverage. This feature prevents reliance on passive water flow patterns and improves the efficiency of sediment removal.

In an alternate embodiment of the present invention, the articulation of the vacuum pipe end is adjusted using a pull cord mechanism. The pull cord extends and retracts to reposition the vacuum pipe within the heater, providing manual control over the cleaning process. This allows users to target specific areas without needing to remove and reinsert the device multiple times.

In an alternate embodiment of the present invention, the vacuum pipe end is inserted through the heating element port after the removal of the lower heating element. This method of access provides a direct path to the bottom of the heater, allowing effective sediment extraction while avoiding obstructions commonly found in the drain valve area.

In an alternate embodiment of the present invention, the vacuum pipe end is inserted through the drain valve opening after the removal of the drain valve. This access point utilizes an existing opening in the water heater, providing a convenient and non-invasive means of sediment removal.

In an alternate embodiment of the present invention, the vacuum pipe end features a motorized articulating joint that enhances control and efficiency. The motorized joint allows automated movement of the vacuum pipe, reducing manual effort and improving precision in targeting sediment deposits. A control interface, such as a wired or wireless remote, may be used to operate the articulation system.

In an alternate embodiment of the present invention, the movement of the vacuum pipe end within the water heater is monitored using an external indicator or sensor system. The sensor provides real-time feedback on the position of the vacuum pipe, ensuring that all areas at the bottom of the heater are covered. The external indicator may include a visual display or electronic tracking system to assist the user in repositioning the vacuum pipe as needed.

In an alternate embodiment of the present invention, the vacuum pipe end includes an extendable section that allows the user to adjust its length to reach different depths within the water heater. The extendable section consists of telescoping tubes or a sliding mechanism that locks into place, providing adaptability for various heater sizes and configurations.

In an alternate embodiment of the present invention, an auxiliary vibrating or pulsating mechanism is attached to the vacuum pipe end to assist in dislodging stubborn deposits. The vibration or pulsation helps break up hardened sediment, making it easier for the vacuum suction to extract the debris. This mechanism may be powered by a small motor, air pulse generator, or integrated pneumatic system.

In an alternate embodiment of the present invention, a sediment detection sensor is positioned on the vacuum pipe end to identify the presence of built-up solids. The sensor detects sediment levels and adjusts the articulation of the vacuum pipe accordingly, ensuring efficient and thorough cleaning. The detection system may use optical, ultrasonic, or pressure-based technology to provide real-time feedback to the user.

In an alternate embodiment of the present invention, a post-vacuum flushing step is performed to remove any residual debris from the water heater. After sediment extraction, the water supply is turned back on, and clean water is flushed through the system to eliminate loosened particles. This step ensures that no residual sediment remains in the tank before it is refilled for normal operation.

In an alternate embodiment of the present invention, the vacuum source comprises a shop vacuum, wet/dry vacuum, or central vacuum system. This design allows for the use of readily available vacuum equipment, eliminating the need for specialized or proprietary components. The vacuum source may be selected based on the level of suction required for different heater sizes and sediment conditions.

In a first preferred embodiment of the present invention, there is a method of cleaning built-up solids from a bottom of a water heater using a water heater clean-out device, the method comprising: A) disconnecting a power supply to a water heater; B) turning off a water supply to said water heater; C) draining said water heater to expose said built-up solids; D) connecting a vacuum source to said water heater clean-out device if not already connected; E) inserting a vacuum pipe end of said water heater clean-out device through an access opening in said water heater; F) activating said vacuum source to create suction through said vacuum pipe end; G) manipulating an articulating joint of said vacuum pipe end to direct it toward said built-up solids at said bottom of said water heater; H) progressively repositioning said vacuum pipe end using a pull cord mechanism to ensure removal of accumulated solids from different areas within said water heater; and I) removing said vacuum pipe end from said water heater and verifying a removal of said built-up solids.

In an alternate embodiment of the present invention, there is a method of cleaning built-up solids from a bottom of a water heater further comprising: A) adjusting an articulation of said vacuum pipe end by extending and retracting a pull cord mechanism to optimize cleaning coverage.

In an alternate embodiment of the present invention, there is a method of cleaning built-up solids from a bottom of a water heater wherein said vacuum pipe end is inserted through a heating element port after removal of a lower heating element.

In an alternate embodiment of the present invention, there is a method of cleaning built-up solids from a bottom of a water heater wherein said vacuum pipe end is inserted through a drain valve opening after removal of a drain valve.

In an alternate embodiment of the present invention, there is a method of cleaning built-up solids from a bottom of a water heater further comprising: A) rotating said vacuum pipe end within said water heater using a motorized articulating joint to enhance cleaning efficiency.

In an alternate embodiment of the present invention, there is a method of cleaning built-up solids from a bottom of a water heater further comprising: A) monitoring a movement of said vacuum pipe end using an external indicator or a sensor to ensure comprehensive coverage of said bottom of said water heater.

In an alternate embodiment of the present invention, there is a method of cleaning built-up solids from a bottom of a water heater further comprising: A) adjusting a length of said vacuum pipe end using an extendable section to reach different depths of said water heater.

In an alternate embodiment of the present invention, there is a method of cleaning built-up solids from a bottom of a water heater further comprising: A) applying a secondary agitation force via an auxiliary vibrating mechanism or an auxiliary pulsating mechanism attached to said vacuum pipe end to assist in dislodging stubborn deposits.

In an alternate embodiment of the present invention, there is a method of cleaning built-up solids from a bottom of a water heater further comprising: A) detecting a presence of said built-up solids using a sensor positioned on said vacuum pipe end and adjusting articulation based on feedback from said sensor.

In an alternate embodiment of the present invention, there is a method of cleaning built-up solids from a bottom of a water heater further comprising: A) flushing said water heater with water after vacuuming to remove any residual debris.

In an alternate embodiment of the present invention, there is a method of cleaning built-up solids from a bottom of a water heater wherein said vacuum source comprises a shop vacuum, a wet/dry vacuum, or a central vacuum system.

Rotation of the vacuum pipe inside the water heater can be achieved by prepositioning a set of vacuum pipes and twisting them while inserting them into a water heater opening. Rotation of the vacuum pipes inside the water heater can be accomplished by rotating the inserted pipe or pipes and articulating joint that are inside the water heater.

The method of using a water heater clean out device comprises a pull cord means such as a pull cord having a pull end and an attachment end wherein said attachment end is connectively attached to said vacuum pipe end enabling a movement of said vacuum pipe end, and optionally a version that further comprises a pulley, a cord reel, a motor, and a user operable control configured to extend and retract said pull cord to bend and/or straighten said vacuum pipe end in relation to said rigid vacuum hose. The pull cord means can also include a set of pulleys to position and move the vacuum pipes that they are attached to to control.

Further, the method of using the water heater clean out device comprises a pull cord means such as a pull cord having a pull end and an attachment end connectively attached to said vacuum pipe end enabling a movement of said vacuum pipe end, and optionally wherein said pull cord means further comprises a pulley, a cord reel, a motor, and a control configured to extend and retract said pull cord to bend and/or straighten said vacuum pipe end in relation to said rigid vacuum hose.

There is actually no clean out opening on a hot water heater but a spot where one replaces the burnt out element (and there is a drain port, which made need to have the valve removed to access with the device of the present invention)

An advantage of the present invention is that it significantly improves the efficiency of water heater maintenance by utilizing a vacuum-based extraction method rather than relying solely on water flushing. Traditional flushing methods often fail to remove all sediment, especially compacted deposits at the bottom of the tank. By incorporating vacuum suction, the present invention ensures more thorough removal of debris, reducing the risk of sediment accumulation over time.

An advantage of the articulating vacuum pipe is that it allows precise positioning of the suction inlet, ensuring that all areas of the water heater's bottom surface are cleaned effectively. Unlike conventional methods where sediment removal is limited by water flow dynamics, the articulating pipe can be directed toward specific problem areas, improving overall cleaning coverage.

An advantage of the pull cord mechanism is that it enables manual repositioning of the vacuum pipe within the water heater without requiring removal and reinsertion of the device. This feature allows for systematic cleaning across the entire base of the tank, ensuring that no sediment pockets remain.

An advantage of providing multiple access points for inserting the vacuum pipe—through the heating element port or the drain valve opening—is that it enhances adaptability for different water heater configurations. This flexibility ensures that the cleaning device can be used on a wide range of residential, commercial, and industrial water heaters without requiring structural modifications.

An advantage of the extendable vacuum pipe section is that it allows for cleaning water heaters of varying depths. The telescoping or adjustable-length pipe can be extended or retracted to optimize its reach, making it useful for different tank sizes without the need for multiple device models.

An advantage of the motorized articulating joint is that it eliminates the need for manual adjustments, providing a more automated and precise method for directing the vacuum pipe end. By integrating motorized articulation, the device can be controlled remotely or pre-programmed to follow a systematic cleaning pattern, reducing user effort and improving efficiency.

An advantage of the auxiliary vibrating or pulsating mechanism is that it assists in dislodging hardened sediment that may not be easily removed by suction alone. This feature enhances cleaning effectiveness by breaking up compacted mineral deposits, allowing the vacuum system to extract even the most stubborn debris.

An advantage of the sediment detection sensor is that it enables real-time monitoring of sediment presence, providing users with feedback on which areas still require cleaning. This feature minimizes guesswork and allows for more efficient and targeted sediment removal, reducing the likelihood of incomplete cleaning cycles.

An advantage of the external indicator system is that it provides a visual or electronic representation of the vacuum pipe's position inside the water heater. This feature ensures that users can track movement and coverage, reducing the chances of missing sediment accumulation in certain areas.

An advantage of the post-vacuum flushing step is that it removes any residual debris after vacuum extraction. By running clean water through the heater after sediment removal, the risk of remaining loose particles settling back into the tank is minimized, ensuring a completely clean water heater before refilling.

An advantage of using a standard shop vacuum, wet/dry vacuum, or central vacuum system as the suction source is that it eliminates the need for expensive, proprietary equipment. Users can utilize existing vacuum systems, making the device cost-effective and easily accessible for both homeowners and professional service providers.

An advantage of the present invention is that it reduces energy consumption and extends the lifespan of the water heater. Sediment buildup can create an insulating layer that forces heating elements to work harder, leading to increased energy costs and premature failure. By effectively removing sediment, the invention ensures optimal heat transfer efficiency and reduces wear on heating components.

An advantage of the invention is that it improves water quality by preventing sediment from being reintroduced into the hot water supply. Accumulated debris can contribute to discoloration, odors, and contamination in household water, which this invention mitigates through thorough sediment extraction.

An advantage of the invention is that it provides a safer and cleaner alternative to traditional water heater maintenance. Manual flushing and sediment removal often involve significant mess and water waste. The vacuum-based system keeps the extraction process contained, minimizing spills and reducing overall maintenance time.

An advantage of the invention for professional service providers is that it reduces maintenance time and labor costs by streamlining the sediment removal process. The efficiency of the device allows technicians to clean multiple water heaters in less time, increasing productivity and customer satisfaction.

An advantage of the invention is that it eliminates the need for repeated maintenance cycles by providing a more effective cleaning process in a single operation. Traditional flushing often requires multiple attempts to remove all sediment, whereas the vacuum-based system ensures immediate and complete extraction.

An advantage of the invention is that it can be integrated with smart monitoring systems for automated diagnostics and predictive maintenance. By connecting sediment detection sensors to a monitoring interface, users can receive alerts when sediment levels reach a critical threshold, prompting timely cleaning before performance is affected.

An advantage of the present invention is that it enhances user convenience by allowing both manual and automated operation. Users can choose to operate the device manually via the pull cord mechanism or take advantage of motorized articulation and sensor-driven automation for a more hands-free experience.

An advantage of the invention is that it can be adapted for use in other fluid storage tanks that experience sediment buildup. While primarily designed for water heaters, the vacuum-based cleaning system may also be applied to industrial boilers, storage tanks, and other systems where sediment accumulation is an issue.

An advantage of the invention is that it supports environmental sustainability by reducing water waste associated with traditional flushing methods. Because the vacuum system directly extracts sediment rather than relying on large volumes of flushing water, it conserves water while still achieving a thorough cleaning.

An advantage of the invention is that it allows for easy maintenance and storage. The vacuum pipe and components are designed to be compact and detachable, making the device convenient to store when not in use. The modular design also allows for easy replacement of individual parts if needed.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A method of cleaning built-up solids from a bottom of a water heater using a water heater clean-out device, the method comprising:
A) disconnecting a power supply to a water heater;
B) turning off a water supply to said water heater;
C) draining said water heater to expose said built-up solids;
D) connecting a vacuum source to said water heater clean-out device if not already connected;
E) inserting a vacuum pipe end of said water heater clean-out device through an access opening in said water heater;
F) activating said vacuum source to create suction through said vacuum pipe end;
G) manipulating an articulating joint of said vacuum pipe end to direct said vacuum pipe end toward said built-up solids at said bottom of said water heater;
H) progressively repositioning said vacuum pipe end using a pull cord mechanism to ensure removal of accumulated solids from different areas within said water heater; and
I) removing said vacuum pipe end from said water heater and verifying a removal of said built-up solids.

2. The method of claim 1, further comprising:
A) adjusting an articulation of said vacuum pipe end by extending and retracting said pull cord mechanism to optimize cleaning coverage.

3. The method of claim 1, wherein said vacuum pipe end is inserted through a heating element port after removal of a lower heating element.

4. The method of claim 1, wherein said vacuum pipe end is inserted through a drain valve opening after removal of a drain valve.

5. The method of claim 1, further comprising:
A) rotating said vacuum pipe end within said water heater using a motorized articulating joint to enhance cleaning efficiency.

6. The method of claim 1, further comprising:
A) monitoring a movement of said vacuum pipe end using an external indicator or a sensor to ensure comprehensive coverage of said bottom of said water heater.

7. The method of claim 1, further comprising:
A) adjusting a length of said vacuum pipe end using an extendable section to reach different depths of said water heater.

8. The method of claim 1, further comprising:
A) applying a secondary agitation force via an auxiliary vibrating mechanism or an auxiliary pulsating mechanism attached to said vacuum pipe end to assist in dislodging stubborn deposits.

9. The method of claim 1, further comprising:
A) detecting a presence of said built-up solids using a sensor positioned on said vacuum pipe end and adjusting articulation based on feedback from said sensor.

10. The method of claim 1, further comprising:
A) flushing said water heater with water after vacuuming to remove any residual debris.

11. The method of claim 1, wherein said vacuum source comprises a shop vacuum, a wet/dry vacuum, or a central vacuum system.
